(19) United States
(12) Patent Application Publication
(10) Pub. No.: US 2026/0029351 A1
(43) Pub. Date: Jan. 29, 2026

(54) SIGNAL FILTERING AND CONCENTRATION INVERSION METHOD FOR INFRARED LASER DETECTION

(71) Applicant: Xi'an university of science and technology, Xi'an (CN)

(72) Inventors: Xiaowei Zhai, Xi'an (CN); Le Hao, Xi'an (CN); Junyang Guo, Xi'an (CN)

(21) Appl. No.: 19/278,719

(22) Filed: Jul. 23, 2025

(30) Foreign Application Priority Data
Jul. 24, 2024 (CN) 202410996604X

(51) Int. Cl. G01N 21/88; G01N 21/01; G01N 21/3504

(52) U.S. Cl. CPC G01N 21/8851; G01N 21/01; G01N 21/3504; G01N 2021/0106; G01N 2021/8883

(57) ABSTRACT

A signal filtering and concentration inversion method for infrared laser detection, implemented through a signal filtering and concentration inversion system for infrared laser detection, includes the following steps: S1, building a transmissive-type infrared laser gas detection system at an on-site detection location, setting fixed parameter information, and establishing normal communication on an optical detection part and obtaining a first-harmonic signal; S2, performing amplification-processing on the first-harmonic signal to obtain a second-harmonic signal, and introducing the second-harmonic signal into a laser filtering-processing model to obtain a denoised second-harmonic signal; S3, inputting the first-harmonic signal and the denoised second-harmonic signal into a concentration inversion model to obtain a concentration signal of a to-be-detected gas; and S4, determining, based on the concentration signal of the to-be-detected gas, whether a hazardous gas limit has been exceeded at the on-site detection location.

### CROSS-REFERENCE TO RELATED APPLICATION

This application claims priority to Chinese Patent Application No. 202410996604.X, filed on Jul. 24, 2024, which is herein incorporated by reference in its entirety.

### TECHNICAL FIELD

The disclosure relates to the field of infrared laser gas detection technologies, and more particularly to a signal filtering and concentration inversion method for infrared laser detection.

### BACKGROUND

In a coal mine production process, underground environment is complex, with a large amount of toxic and harmful gases such as methane and carbon monoxide, which seriously threaten production safety. Therefore, real-time and accurate monitoring of underground gas concentrations is crucial for ensuring safe production of coal mines. Infrared laser gas detection technology has advantages of fast analysis speed, low cost, no sample consumption, and easy online measurement. However, in actual use, infrared laser detection is often interfered with by various types of noise, such as equipment vibration and electromagnetic interference, which seriously affects accuracy of the infrared laser detection.

For example, a patent “Laser Photoacoustic Spectrometry Gas Detection Device and Method Based on Acousto-optic Frequency Shifting and Locking Technology” with a Chinese patent application No. 202110695646.6 (corresponding to Chinese patent publication No. CN114136921A), filed on Jun. 23, 2021, employs the acousto-optic frequency shifting and locking technology to achieve rapid and precise frequency locking and tuning of continuous light sources. Moreover, a patent “Laser Infrared Gas Concentration Detection Method and System Based on Dynamic Absorption Line” with a Chinese patent application No. 202210480618.7 (corresponding to Chinese patent publication No. CN115015149A), field on May 5, 2022, achieves accurate detection by modulating laser current in real-time to lock a wavelength range. However, the above patents do not take into account interference from rectification effects, ripples, and noise signals, which still leads to insufficient detection accuracy in special environments. Currently, there is an urgent need for a gas detection device combining signal filtering with concentration inversion to meet high-precision gas detection requirements in complex underground environments.

### SUMMARY

A purpose of the disclosure is to provide a signal filtering and concentration inversion method for infrared laser detection, thereby solving a problem of insufficient detection accuracy in special environments due to the lack of consideration of interference from rectification effects, ripples, and noise signals in the related art.

A technical solution adapted in the disclosure is a signal filtering and concentration inversion method for infrared laser detection, being implemented through a signal filtering and concentration inversion system for infrared laser detection and including the following steps:
S1, building a transmissive-type infrared laser gas detection system at an on-site detection location, setting fixed parameter information and establishing normal communication of an optical detection part, and obtaining a first-harmonic signal;
S2, performing amplification-processing on the first-harmonic signal to obtain a second-harmonic signal, and introducing the second-harmonic signal into a signal filtering model to obtain a denoised second-harmonic signal;
S3, inputting the first-harmonic signal and the denoised second-harmonic signal into a concentration inversion model to obtain a concentration signal of a to-be-detected gas; and
S4, determining, based on the concentration signal of the to-be-detected gas, whether a hazardous gas limit has been exceeded at the on-site detection location, in response to the hazardous gas limit has been exceeded, initiating emergency measures and sending an alarm to a host computer, in response to the hazardous gas limit has not been exceeded, continuing reading data of next period for signal filtering and concentration inversion.

Characteristics of the disclosure are further as follows.

The transmissive-type infrared laser gas detection system (also referred to as opposed infrared laser gas detection system) includes a laser emitter, a laser beam expander, a gas cell, a reflection mirror, a laser detector, a lock-in amplifier, a laser driver, a data acquisition card and an industrial personal computer. The laser beam expander 2 is disposed at an outlet of the laser emitter. The reflection mirror is disposed on a side of the laser beam expander facing away from the laser emitter. The gas cell is disposed between the laser beam expander and the reflection mirror. The laser emitter, the laser expander, the gas cell and the reflection mirror are aligned on a same straight line. The reflection mirror is signal-connected to the laser detection. The laser emitter is connected to the laser driver via a butterfly laser serial port. The laser emitter is further connected to a lock-in amplifier via a SubMiniature version A (SMA) radio frequency cable. The lock-in amplifier is connected to the laser detector via an SMA radio frequency cable, and the lock-in amplifier is further connected to the data acquisition card via an SMA radio frequency cable. The data acquisition card is connected to the industrial personal computer via a universal serial bus (USB) communication cable. The industrial personal computer is equipped with the signal filtering and concentration inversion system including the signal filtering model and the concentration inversion model and is configured to send the alarm and an emergency response signal to the host computer.

In an embodiment, the step S1 includes the following sub-steps:
S1.1, connecting a communication serial port of the industrial personal computer with a communication serial port of the lock-in amplifier via a USB interface, and connecting another communication serial port of the industrial personal computer with a communication serial port of the data acquisition card via another USB interface;
S1.2, setting parameter information including a voltage and a temperature of the laser driver, the communication serial port, a phase angle, a frequency, an amplitude range and a modulation amplitude of the lock-in amplifier, and a sampling frequency of the data acquisition card; then storing the parameter information and saving as the fixed parameter information; and after debugging, considering the communication is normal when the industrial personal computer can successfully read the first-harmonic signal and the second-harmonic signal from the data acquisition card;
S1.3, installing the transmissive-type infrared laser gas detection system being set with the fixed parameter information at the on-site detection location prone to gas leaks for real-time detection; and
S1.4, completing parameter adjustment for the transmissive-type infrared laser gas detection system to obtain the transmissive-type infrared laser gas detection system for later use.

In an embodiment, a process for obtaining the denoised second-harmonic signal in the step S2 includes the following sub-steps:
S2.1, reading the first-harmonic signal obtained in the step S1, and then modulating by the lock-in amplifier to obtain the second-harmonic signal;
S2.2, taking the second-harmonic signal within 1 second as a baseline, and removing ripples of the second-harmonic signal by using Savitzky-Golay filtering to obtain a processed harmonic signal;
S2.3, reading the processed harmonic signal and then inputting into an empirical mode decomposition (EMD) method, and decomposing the processed harmonic signal into 15 mode component signals of different frequencies by using the EMD method;
S2.4, reading the 15 mode component signals of different frequencies and sorting as per frequencies from high to low, namely, an order number of the mode component signal with a highest frequency is labelled as 1 and an order number of the mode component signal with a lowest frequency is labelled as 15; and selecting high-frequency mode component signals with order numbers of 8, 9 and 10 from the 15 mode component signals of different frequencies for wavelet transform filtering to obtain wavelet-transformed high-frequency mode component signals with the order numbers of 8, 9 and 10; and
S2.5, reading the wavelet-transformed high-frequency mode component signals with the order numbers of 8, 9 and 10 and low-frequency mode component signals with order numbers of 11 through 15 from the 15 mode component signals of different frequencies, and then linearly superimposing to obtain the denoised second-harmonic signal after filtering-processing.

In an embodiment, in the Savitzky-Golay filtering in the sub-step S2.2, a fixed fitting order is set to 3, and a fitting window size is set to 191.

In an embodiment, in the wavelet transform filtering, a fixed transformation coupling order is set to 5, and a wavelet basis type is Daubechies 10 (dB 10).

In an embodiment, a process for obtaining the concentration signal of the to-be-detected gas in the step S3 includes the following sub-steps:
S3.1, acquiring the first-harmonic signal and the denoised second-harmonic signal in real time;
S3.2, setting a signal start threshold V₁ and a range value T₁ of the first-harmonic signal;
S3.3, truncating in real time the first-harmonic signal and the denoised second-harmonic signal in a same detection frequency, namely, when an amplitude of a triangular wave in the first-harmonic signal reaches the signal start threshold V₁, truncating the denoised second-harmonic signal at a same time period, and then extending backwards the denoised second-harmonic signal with a duration of T₁ to obtain a second-harmonic voltage signal containing characteristic gas signal;
S3.4, reading the second-harmonic voltage signal containing characteristic gas signal obtained in the sub-step S3.3, performing superposition mean calculation on periodic signals within 1 second extracted from the second-harmonic voltage signal containing characteristic gas signal as per the following formula (1), then subtracting a standalone second-harmonic signal detected in ambient air to obtain a characteristic second-harmonic signal, and inputting the characteristic second-harmonic signal into the concentration inversion model to obtain a real-time concentration value of the to-be-detected gas, where the formula (1) is expressed as follows:

$$f ( {x}_{i} ) = \frac{{\sum }_{i = 1}^{n} f ( {x}_{i , j} )}{n} \qquad ( 1 )$$

where f(xᵢ) represents an output mean value after averaging the periodic signals within 1 second, f(x_{i,j}) represents an i-th voltage amplitude of a j-th one of the periodic signals within 1 second, and n represents a total number of the periodic signals within 1 second.

In an embodiment, a process for obtaining the concentration inversion model in the step S3.4 includes the following sub-steps:
S3.4.1, acquiring filtering-processed second-harmonic historical data;
S3.4.2, subtracting a standalone second-harmonic signal detected in ambient air from a second-harmonic signal containing characteristic gas signal in the filtering-processed second-harmonic historical data, to obtain a harmonic signal containing only gas characteristic;
S3.4.3, reading the harmonic signal containing only gas characteristic obtained in the sub-step S3.4.2, and calculating a maximum voltage value max f(x) of the harmonic signal containing only gas characteristic;
S3.4.4, constructing a linear function between the maximum voltage value and a gas characteristic concentration as per the following formula (2):

$$C ( x ) = a * maxf ( x ) + b \qquad ( 2 )$$

where C(x) represents a gas concentration value corresponding to the maximum voltage value max f(x), and a and b represent dimensionless coefficients for the concentration inversion model; and
S3.4.5, obtaining the concentration inversion model, and substituting a maximum voltage amplitude of the characteristic second-harmonic signal detected in real time into the formula (2) to obtain the real-time concentration value of the to-be-detected gas.

The disclosure may achieve the following beneficial effects.

The signal filtering and concentration inversion method for infrared laser detection provided by the disclosure, through signal filtering and concentration inversion, achieves noise suppression, enhanced detection sensitivity and signal-noise ratio in complex underground environments, thereby enabling precise signal detection and accurate concentration inversion. Moreover, when the gas concentration reaches a hazardous level, the alarm and the emergency response signal are sent to command center to prevent significant safety hazards.

### BRIEF DESCRIPTION OF DRAWINGS

FIG. 1 illustrates a schematic structural diagram of a transmissive-type infrared laser gas detection system equipped with a signal filtering and concentration inversion system for infrared laser detection of the disclosure.

FIG. 2 illustrates a flowchart of a signal filtering and concentration inversion method for infrared laser detection of the disclosure.

FIG. 3 illustrates a flowchart of a parameter adjustment process in the signal filtering and concentration inversion method for infrared laser detection of the disclosure.

FIG. 4 illustrates a flowchart of a signal filtering process in the signal filtering and concentration inversion method for infrared laser detection of the disclosure.

FIG. 5 illustrates a flowchart of a gas concentration inversion process in the signal filtering and concentration inversion method for infrared laser detection of the disclosure.

FIG. 6 illustrates a schematic diagram for obtaining a concentration inversion model in the signal filtering and concentration inversion method for infrared laser detection of the disclosure.

FIG. 7 illustrates a schematic structural diagram of the transmissive-type infrared laser gas detection system sending an alarm to a host computer when a hazardous gas limit has been exceeded of the disclosure.

### DESCRIPTION OF REFERENCE SIGNS

1—laser emitter; 2—laser beam expander; 3—gas cell; 4—reflection mirror; 5—laser detector; 6—lock—in amplifier; 7—laser driver; 8—data acquisition card; 9—industrial personal computer; 10—host computer.

### DETAILED DESCRIPTION OF EMBODIMENTS

The disclosure will be described in detail with reference to attached drawings and specific embodiments.

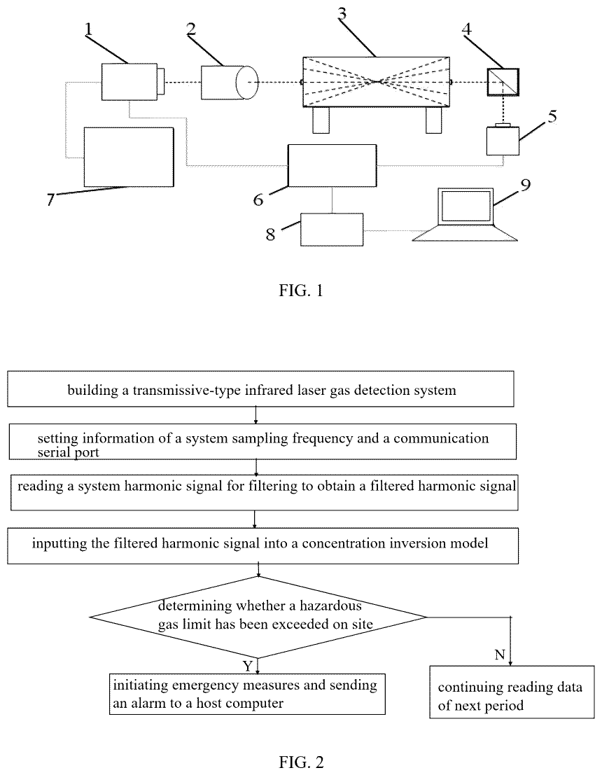

A signal filtering and concentration inversion method for infrared laser detection is implemented through a signal filtering and concentration inversion system for infrared laser detection embedded in a transmissive-type infrared laser gas detection system. Specifically, as shown in FIG. 1 and FIG. 7, the transmissive-type infrared laser gas detection system includes a laser emitter 1. The laser emitter 1 is configured to emit infrared laser light of a specific wavelength band. A laser beam expander 2 is disposed at an outlet of the laser emitter 1, and the laser beam expander 2 is configured to convert an optical signal in a fiber into a spatial optical signal. A reflection mirror 4 is disposed on a side of the laser beam expander 2 facing away from the laser emitter 1. A gas cell 3 is disposed between the laser beam expander 2 and the reflection mirror 4. The laser emitter 1, the laser expander 2, the gas cell 3 and the reflection mirror 4 are aligned on a same straight line. The reflection mirror 4 is signal-connected to a laser detector 5. The laser emitter 1 is connected to a laser driver 7 via a butterfly laser serial port. The laser driver 7 is configured to adjust a drive voltage and an operating temperature of the laser emitter 1 to regulate a center wavelength of the infrared laser light emitted by the laser emitter 1.

The laser emitter 1 is further connected to a lock-in amplifier 6 via an SMA radio frequency cable. The lock-in amplifier 6 is connected to the laser detector 5 via an SMA radio frequency cable and is further connected to a data acquisition card 8 via an SMA radio frequency cable. The data acquisition card 8 is connected to an industrial personal computer 9 via a USB communication cable. The industrial personal computer 9 is equipped with the signal filtering and concentration inversion system and is configured to send an alarm and an emergency response signal to a host computer 10. Specifically, the signal filtering and concentration inversion system includes a signal filtering model and a concentration inversion model.

In an embodiment, a voltage signal transmitted by the laser detector 5 is received by the lock-in amplifier 6, and the lock-in amplifier 6 amplifies a first-harmonic signal (i.e., the voltage signal) to obtain an amplified signal. Then the amplified signal is sent to the data acquisition card 8. The laser detector 5 is connected to the reflection mirror 4 via a wire. The data acquisition card 8 is connected to the industrial personal computer 9 via a wire. The industrial personal computer 9 is equipped with the signal filtering and concentration inversion system and is configured to send the alarm and the emergency response signal to the host computer 10.

Structured light generated by the laser emitter 1 passes through the laser beam expander 2, then through the gas cell 3 to the reflection mirror 4, and finally the laser detector 5 receives attenuated laser light and converts the light signal into the voltage signal.

The voltage signal transmitted by the laser detector 5 is received by the lock-in amplifier 6, and the lock-in amplifier 6 amplifies the first-harmonic signal to obtain the amplified signal. Then the amplified signal is sent to the data acquisition card 8. The data acquisition card 8 continuously reads voltage signal data of the first-harmonic signal and a second-harmonic signal (i.e., the amplified signal), and then the voltage signal data is transmitted to the industrial personal computer 9.

As shown in FIG. 2, the signal filtering and concentration inversion method for infrared laser detection is implemented through the signal filtering and concentration inversion system for infrared laser detection embedded in the transmissive-type infrared laser gas detection system and includes the following steps S1 through S4.

In the step S1, at an on-site detection location, the transmissive-type infrared laser gas detection system is building, and fixed parameter information is set. Normal communication of an optical detection part is established, and a first-harmonic signal is obtained. Specifically, the optical detection part includes the laser emitter 1, the laser beam expander 2, the gas cell 3, the reflection mirror 4, and the laser detector 5 of the transmissive-type infrared laser gas detection system.

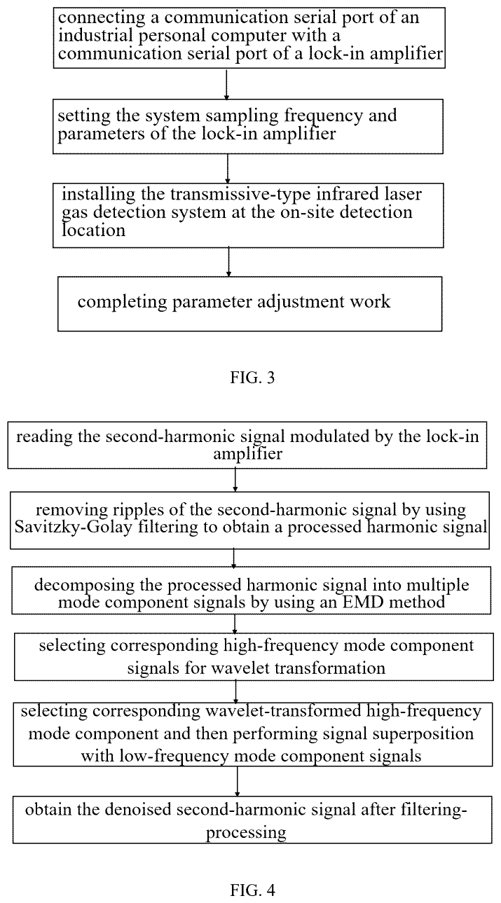

As shown in FIG. 3, the step S1 includes the following sub-steps S1.1 through S1.4.

In the sub-step S1.1, a communication serial port of the industrial personal computer 9 is connected with a communication serial port of the lock-in amplifier 6 via a USB interface, and another communication serial port of the industrial personal computer 9 is connected with a communication serial port of the data acquisition card 8 via a USB interface.

In the sub-step S1.2, parameter information is set. The parameter information includes a voltage and a temperature of the laser driver 7, the communication serial port, a phase angle, a frequency, an amplitude range and a modulation amplitude of the lock-in amplifier 6, and a sampling frequency of the data acquisition card 8. Then the parameter information is stored and is saved as the fixed parameter information. After the above debugging, when the industrial personal computer 9 can successfully read the first-harmonic signal and the second-harmonic signal from the data acquisition card 8, the communication is considered normal.

In the sub-step S1.3, the transmissive-type infrared laser gas detection system being set with the fixed parameter information is installed at the on-site detection location prone to gas leaks for real-time detection.

In the sub-step S1.4, parameter adjustment for the transmissive-type infrared laser gas detection system is completed to obtain the transmissive-type infrared laser gas detection system for later use.

In the step S2, the first-harmonic signal is processed to obtain a second-harmonic signal. Then the second-harmonic signal is introduced into the signal filtering model to obtain a denoised second-harmonic signal.

As shown in FIG. 4, a specific process for obtaining the denoised second-harmonic signal in the step S2 includes the following sub-steps S2.1 through S2.5.

In the sub-step S2.1, the first-harmonic signal obtained in the step S1 is read, and then is modulated by the lock-in amplifier 6 to obtain the second-harmonic signal.

In the sub-step S2.2, the second-harmonic signal within 1 second is used as a baseline. Ripples of the second-harmonic signal are removed by using Savitzky-Golay filtering to obtain a processed harmonic signal. Specifically, in the Savitzky-Golay filtering, a fixed fitting order is set to 3, and a fitting window size is set to 191.

In the sub-step S2.3, the processed harmonic signal is read and then input into an EMD method. The processed harmonic signal is decomposed into 15 mode component signals of different frequencies by using the EMD method.

In the sub-step S2.4, the 15 mode component signals of different frequencies are read and sorted as per frequencies from high to low. Namely, an order number of the mode component signal with a highest frequency is labelled as 1 and an order number of the mode component signal with a lowest frequency is labelled as 15. High-frequency mode component signals with order numbers of 8, 9 and 10 from the 15 mode component signals of different frequencies are selected for wavelet transform filtering to obtain wavelet-transformed high-frequency mode component signals with the order numbers of 8, 9 and 10.

In the sub-step S2.5, the wavelet-transformed high-frequency mode component signals with the order numbers of 8, 9 and 10 and low-frequency mode component signals with order numbers of 11 through 15 from the 15 mode component signals of different frequencies are read and linearly superimposed to obtain the denoised second-harmonic signal after filtering-processing.

Specifically, in the wavelet transform filtering, a fixed transformation coupling order is set to 5, and a wavelet basis type is dB 10.

In the step S3, the first-harmonic signal obtained in the step S1 and the denoised second-harmonic signal obtained in the step S2 are read and then input into the concentration inversion model to obtain a concentration signal of a to-be-detected gas.

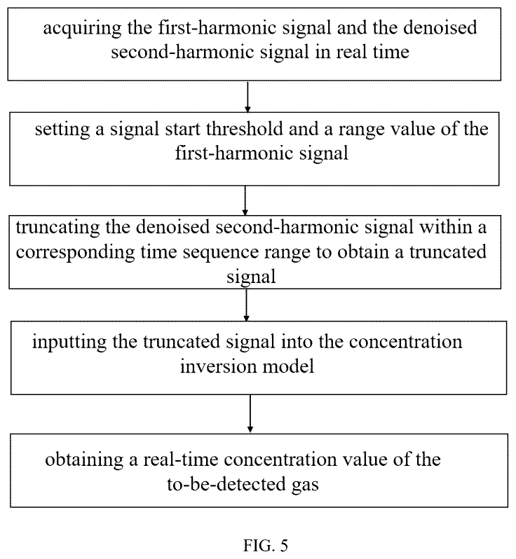

As shown in FIG. 5, a specific process for obtaining the concentration signal of the to-be-detected gas in the step S3 includes the following sub-steps S3.1 through S3.4.

In the sub-step S3.1, the first-harmonic signal and the denoised second-harmonic signal are acquired in real time.

In the sub-step S3.2, a signal start threshold V₁ and a range value T₁ of the first-harmonic signal are set.

In the step sub-S3.3, the first-harmonic signal and the denoised second-harmonic signal in a same detection frequency are truncated in real time. Specifically, when an amplitude of a triangular wave in the first-harmonic signal reaches the signal start threshold V₁, the denoised second-harmonic signal at a same time period is truncated and then is extended backwards with a duration of T₁ to obtain a second-harmonic voltage signal containing characteristic gas signal.

In the sub-step S3.4, the second-harmonic voltage signal containing characteristic gas signal obtained in the sub-step S3.3 is read. Superposition mean calculation is performed on periodic signals within 1 second extracted from the second-harmonic voltage signal containing characteristic gas signal as per the following formula (1). Then a standalone second-harmonic signal detected in ambient air is subtracted to obtain a characteristic second-harmonic signal. The characteristic second-harmonic signal is input into the concentration inversion model to obtain a real-time concentration value of the to-be-detected gas. The formula (1) is expressed as follows:

$$f ( {x}_{i} ) = \frac{{\sum }_{i = I}^{n} f ( {x}_{i , j} )}{n}$$

where f(xᵢ) represents an output mean value after averaging the periodic signals within 1 second, in a unit of V; f(x_{i,j}) represents an i-th voltage amplitude of a j-th one of the periodic signals within 1 second; and n represents a total number of the periodic signals within 1 second.

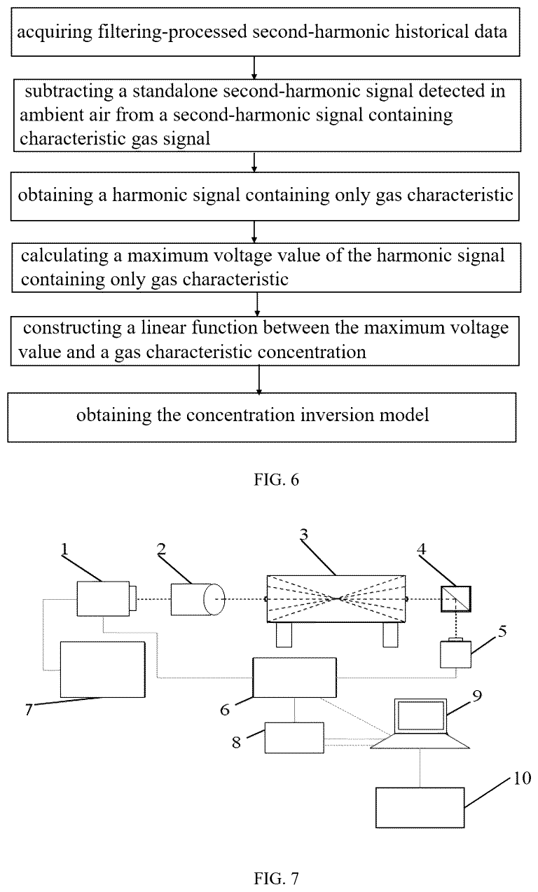

As shown in FIG. 6, a specific process for obtaining the concentration inversion model in the sub-step S3.4 includes the following sub-steps S3.4.1 through S3.4.5.

In the sub-step S3.4.1, filtering-processed second-harmonic historical data is acquired.

In the sub-step S3.4.2, a standalone second-harmonic detected in ambient air is subtracted from a second-harmonic signal containing characteristic gas signal in the filtering-processed second-harmonic historical data, to obtain a harmonic signal containing only gas characteristic.

In the sub-step S3.4.3, the harmonic signal containing only gas characteristic obtained in the sub-step S3.4.2 is read, and a maximum voltage value max f(x) of the harmonic signal containing only gas characteristic is calculated.

In the sub-step S3.4.4, a linear function between the maximum voltage value and a gas characteristic concentration is constructed as per the following formula (2):

$$C ( x ) = a * maxf ( x ) + b \qquad ( 2 )$$

where C(x) represents a gas concentration value corresponding to the maximum voltage value max f(x), and a and b represent dimensionless coefficients for the concentration inversion model.

In the sub-step S3.4.5, the concentration inversion model is obtained. A maximum voltage amplitude of the characteristic second-harmonic signal detected in real time is input into the formula (2) to obtain the real-time concentration value of the to-be-detected gas.

In the step S4, based on the concentration signal of the to-be-tested gas, whether a hazardous gas limit has been exceeded at the on-site detection location is determined. In response to the hazardous gas limit has been exceeded, emergency measures are initiated, and the alarm is sent to a host computer 10, as shown in FIG. 7. In response to the hazardous gas limit has been exceeded, data of next period is read for signal filtering and concentration inversion.

### First Embodiment

A signal filtering and concentration inversion method for infrared laser detection is implemented through a signal filtering and concentration inversion system for infrared laser detection embedded in a transmissive-type infrared laser gas detection system. Specifically, as shown in FIG. 1 and FIG. 7, the transmissive-type infrared laser gas detection system includes a laser emitter 1. The laser emitter 1 is configured to emit infrared laser light of a specific wavelength band. A laser beam expander 2 is disposed at an outlet of the laser emitter 1, and the laser beam expander 2 is configured to convert an optical signal in a fiber into a spatial optical signal. A reflection mirror 4 is disposed on a side of the laser beam expander 2 facing away from the laser emitter 1. A gas cell 3 is disposed between the laser beam expander 2 and the reflection mirror 4. The laser emitter 1, the laser expander 2, the gas cell 3 and the reflection mirror 4 are aligned on a same straight line. The reflection mirror 4 is signal-connected to a laser detector 5. The laser emitter 1 is connected to a laser driver 7 via a butterfly laser serial port. The laser driver 7 is configured to adjust a drive voltage and an operating temperature of the laser emitter 1 to regulate a center wavelength of the infrared laser light emitted by the laser emitter 1.

The laser emitter 1 is further connected to a lock-in amplifier 6 via an SMA radio frequency cable. The lock-in amplifier 6 is connected to the laser detector 5 via an SMA radio frequency cable and is further connected to a data acquisition card 8 via an SMA radio frequency cable. The data acquisition card 8 is connected to an industrial personal computer 9 via a USB communication cable. The industrial personal computer 9 is equipped with the signal filtering and concentration inversion system and is configured to send an alarm and an emergency response signal to a host computer 10. Specifically, the signal filtering and concentration inversion system includes a signal filtering model and a concentration inversion model.

In an embodiment, a voltage signal transmitted by the laser detector 5 is received by the lock-in amplifier 6, and the lock-in amplifier 6 amplifies a first-harmonic signal (i.e., the voltage signal) to obtain an amplified signal. Then the amplified signal is sent to the data acquisition card 8. The laser detector 5 is connected to the reflection mirror 4 via a wire. The data acquisition card 8 is connected to the industrial personal computer 9 via a wire. The industrial personal computer 9 is equipped with the signal filtering and concentration inversion system and is configured to send the alarm and the emergency response signal to the host computer 10.

Structured light generated by the laser emitter 1 passes through the laser beam expander 2, then through the gas cell 3 to the reflection mirror 4, and finally the laser detector 5 receives attenuated laser light and converts the light signal into the voltage signal.

The voltage signal transmitted by the laser detector 5 is received by the lock-in amplifier 6, and the lock-in amplifier 6 amplifies the first-harmonic signal to obtain the amplified signal. Then the amplified signal is sent to the data acquisition card 8. The data acquisition card 8 continuously reads voltage signal data of the first-harmonic signal and a second-harmonic signal (i.e., the amplified signal), and then the voltage signal data is transmitted to the industrial personal computer 9.

### Second Embodiment

As shown in FIG. 2, a signal filtering and concentration inversion method for infrared laser detection is implemented through a signal filtering and concentration inversion system for infrared laser detection embedded in a transmissive-type infrared laser gas detection system and includes the following steps S1 through S4.

In the step S1, at an on-site detection location, the transmissive-type infrared laser gas detection system is building, and fixed parameter information is set. Normal communication of an optical detection part is established, and a first-harmonic signal is obtained. Specifically, as shown in FIG. 1, the optical detection part includes a laser emitter 1, a laser beam expander 2, a gas cell 3, a reflection mirror 4, and a laser detector 5 of the transmissive-type infrared laser gas detection system.

In the step S2, the first-harmonic signal is processed to obtain a second-harmonic signal. Then the second-harmonic signal is introduced into a signal filtering model to obtain a denoised second-harmonic signal.

In the step S3, the first-harmonic signal obtained in the step S1 and the denoised second-harmonic signal obtained in the step S2 are read and then input into a concentration inversion model to obtain a concentration signal of a to-be-detected gas.

In the step S4, based on the concentration signal of the to-be-tested gas, whether a hazardous gas limit has been exceeded at the on-site detection location is determined. In response to the hazardous gas limit has been exceeded, emergency measures are initiated, and an alarm is sent to a host computer 10, as shown in FIG. 7. In response to the hazardous gas limit has been exceeded, data of next period is read for signal filtering and concentration inversion.

### Third Embodiment

As shown in FIG. 2, a signal filtering and concentration inversion method for infrared laser detection is implemented through a signal filtering and concentration inversion system for infrared laser detection embedded in the transmissive-type infrared laser gas detection system and includes the following steps S1 through S4.

In step S1, at an on-site detection location, the transmissive-type infrared laser gas detection system is building, and fixed parameter information is set. Normal communication of an optical detection part is established, and a first-harmonic signal is obtained. Specifically, as shown in FIG. 1, the optical detection part includes the laser emitter 1, the laser beam expander 2, the gas cell 3, the reflection mirror 4, and the laser detector 5 of the transmissive-type infrared laser gas detection system.

In the step S2, the first-harmonic signal is processed to obtain a second-harmonic signal. Then the second-harmonic signal is introduced into a signal filtering model to obtain a denoised second-harmonic signal.

In the step S3, the first-harmonic signal obtained in the step S1 and the denoised second-harmonic signal obtained in the step S2 are read and then input into a concentration inversion model to obtain a concentration signal of a to-be-detected gas.

As shown in FIG. 5, a specific process for obtaining the concentration signal of the to-be-detected gas in the step S3 includes the following sub-steps S3.1 through S3.4.

In the sub-step S3.1, the first-harmonic signal and the denoised second-harmonic signal are acquired in real time.

In the sub-step S3.2, a signal start threshold V₁ and a range value T₁ of the first-harmonic signal are set.

In the sub-step S3.3, the first-harmonic signal and the denoised second-harmonic signal in a same detection frequency are truncated in real time. Specifically, when an amplitude of a triangular wave in the first-harmonic signal reaches the signal start threshold V₁, the denoised second-harmonic signal at a same time period is truncated and then is extended backwards with a duration of T₁ to obtain second-harmonic voltage signal containing characteristic gas signal.

In the sub-step S3.4, the second-harmonic voltage signal containing characteristic gas signal obtained in the sub-step S3.3 is read. Superposition mean calculation is performed on periodic signals within 1 second extracted from the second-harmonic voltage signal containing characteristic gas signal as per the following formula (1). Then a standalone second-harmonic signal detected in ambient air is subtracted to obtain a characteristic second-harmonic signal. The characteristic second-harmonic signal is input into the concentration inversion model to obtain a real-time concentration value of the to-be-detected gas. The formula (1) is expressed as follows:

$$f ( {x}_{i} ) = \frac{{\sum }_{i = 1}^{n} f ( {x}_{i , j} )}{n}$$

where f(xᵢ) represents an output mean value after averaging the periodic signals within 1 second, in a unit of V; f(x_{i,j}) represents an i-th voltage amplitude of a j-th one of the periodic signals within 1 second; and n represents a total number of the periodic signals within 1 second.

As shown in FIG. 6, a specific process for obtaining the concentration inversion model in the sub-step S3.4 includes the following sub-steps S3.4.1 through S3.4.5.

In the sub-step S3.4.1, filtering-processed second-harmonic historical data is acquired.

In the sub-step S3.4.2, a standalone second-harmonic detected in ambient air is subtracted from a second-harmonic signal containing characteristic gas signal in the filtering-processed second-harmonic historical data, to obtain a harmonic signal containing only gas characteristic.

In the sub-step S3.4.3, the harmonic signal containing only gas characteristic obtained in the sub-step S3.4.2 is read, and a maximum voltage value max f(x) of the harmonic signal containing only gas characteristic is calculated.

In the sub-step S3.4.4, a linear function between the maximum voltage value and a gas characteristic concentration as per the following formula (2) is constructed:

$$C ( x ) = a * maxf ( x ) + b \qquad ( 2 )$$

where C(x) represents a gas concentration value corresponding to the maximum voltage value max f(x), and a and b represent dimensionless coefficients for the concentration inversion model.

In the sub-step S3.4.5, the concentration inversion model is obtained. A maximum voltage amplitude of the characteristic second-harmonic signal detected in real time is input into the formula (2) to obtain the real-time concentration value of the to-be-detected gas.

In the step S4, based on the concentration signal of the to-be-tested gas, whether a hazardous gas limit has been exceeded at the on-site detection location is determined. In response to the hazardous gas limit has been exceeded, emergency measures are initiated, and an alarm is sent to a host computer 10, as shown in FIG. 7. In response to the hazardous gas limit has been exceeded, data of next period is read for signal filtering and concentration inversion.

What is claimed is:

1. A signal filtering and concentration inversion method for infrared laser detection, being implemented through a signal filtering and concentration inversion system for infrared laser detection and comprising the following steps:
S1, building a transmissive-type infrared laser gas detection system at an on-site detection location, setting fixed parameter information and establishing normal communication of an optical detection part, and obtaining a first-harmonic signal;
S2, performing amplification-processing on the first-harmonic signal to obtain a second-harmonic signal, and introducing the second-harmonic signal into a signal filtering model to obtain a denoised second-harmonic signal;
S3, inputting the first-harmonic signal and the denoised second-harmonic signal into a concentration inversion model to obtain a concentration signal of a to-be-detected gas; and
S4, determining, based on the concentration signal of the to-be-detected gas, whether a hazardous gas limit has been exceeded at the on-site detection location, in response to the hazardous gas limit has been exceeded, initiating emergency measures and sending an alarm to a host computer (10), in response to the hazardous gas limit has not been exceeded, continuing reading data of next period for signal filtering and concentration inversion.

2. The signal filtering and concentration inversion method for infrared laser detection as claimed in claim 1, wherein the transmissive-type infrared laser gas detection system comprises a laser emitter (1), a laser beam expander (2), a gas cell (3), a reflection mirror (4), a laser detector (5), a lock-in amplifier (6), a laser driver (7), a data acquisition card (8), and an industrial personal computer (9);
wherein the laser beam expander (2) is disposed at an outlet of the laser emitter (1), the reflection mirror (4) is disposed on a side of the laser beam expander (2) facing away from the laser emitter (1), and the gas cell (3) is disposed between the laser beam expander (2) and the reflection mirror (4); the laser emitter (1), the laser beam expander (2), the gas cell (3) and the reflection mirror (4) are aligned on a same straight line; and the reflection mirror (4) is signal-connected to the laser detector (5), and the laser emitter (1) is connected to the laser driver (7) via a butterfly laser serial port; and
wherein the laser emitter (1) is further connected to the lock-in amplifier (6) via a SubMiniature version A (SMA) radio frequency cable, the lock-in amplifier (6) is connected to the laser detector (5) via an SMA radio frequency cable, the lock-in amplifier (6) is further connected to the data acquisition card (8) via an SMA radio frequency cable, the data acquisition card (8) is connected to the industrial personal computer (9) via a universal serial bus (USB) communication cable, and the industrial personal computer (9) is equipped with the signal filtering and concentration inversion system including the signal filtering model and the concentration inversion model and is configured to send the alarm and an emergency response signal to the host computer (10).

3. The signal filtering and concentration inversion method for infrared laser detection as claimed in claim 1, wherein the step S1 comprises the following sub-steps:
S1.1, connecting a communication serial port of an industrial personal computer (9) with a communication serial port of a lock-in amplifier (6) via a USB interface, and connecting another communication serial port of the industrial personal computer (9) with a communication serial port of a data acquisition card (8) via another USB interface;
S1.2, setting parameter information comprising a voltage and a temperature of a laser driver (7), the communication serial port, a phase angle, a frequency, an amplitude range and a modulation amplitude of the lock-in amplifier (6), and a sampling frequency of the data acquisition card (8); then storing the parameter information and saving as the fixed parameter information; and after debugging, considering the communication is normal when the industrial personal computer (9) can successfully read the first-harmonic signal and the second-harmonic signal from the data acquisition card (8);
S1.3, installing the transmissive-type infrared laser gas detection system being set with the fixed parameter information at the on-site detection location prone to gas leaks for real-time detection; and
S1.4, completing parameter adjustment for the transmissive-type infrared laser gas detection system to obtain the transmissive-type infrared laser gas detection system for later use.

4. The signal filtering and concentration inversion method for infrared laser detection as claimed in claim 1, wherein a process for obtaining the denoised second-harmonic signal in the step S2 comprises the following sub-steps:
S2.1, reading the first-harmonic signal obtained in the step S1, and then modulating by a lock-in amplifier (6) to obtain the second-harmonic signal;
S2.2, taking the second-harmonic signal within 1 second as a baseline, and removing ripples of the second-harmonic signal by using Savitzky-Golay filtering to obtain a processed harmonic signal;
S2.3, reading the processed harmonic signal and then inputting into an empirical mode decomposition (EMD) method, and decomposing the processed harmonic signal into 15 mode component signals of different frequencies by using the EMD method;
S2.4, reading the 15 mode component signals of different frequencies and sorting as per frequencies from high to low, namely, an order number of the mode component signal with a highest frequency is labelled as 1 and an order number of the mode component signal with a lowest frequency is labelled as 15; and selecting high-frequency mode component signals with order numbers of 8, 9 and 10 from the 15 mode component signals of different frequencies for wavelet transform filtering to obtain wavelet-transformed high-frequency mode component signals with the order numbers of 8, 9 and 10; and
S2.5, reading the wavelet-transformed high-frequency mode component signals with the order numbers of 8, 9 and 10 and low-frequency mode component signals with order numbers of 11 through 15 from the 15 mode component signals of different frequencies, and then linearly superimposing to obtain the denoised second-harmonic signal after filtering-processing.

5. The signal filtering and concentration inversion method for infrared laser detection as claimed in claim 4, wherein in the Savitzky-Golay filtering in the sub-step S2.2, a fixed fitting order is set to 3, and a fitting window size is set to 191.

6. The signal filtering and concentration inversion method for infrared laser detection as claimed in claim 4, wherein in the wavelet transform filtering, a fixed transformation coupling order is set to 5, and a wavelet basis type is Daubechies 10 (dB 10).

7. The signal filtering and concentration inversion method for infrared laser detection as claimed in claim 1, wherein a process for obtaining the concentration signal of the to-be-detected gas in the step S3 comprises the following sub-steps:
S3.1, acquiring the first-harmonic signal and the denoised second-harmonic signal in real time;
S3.2, setting a signal start threshold V₁ and a range value T₁ of the first-harmonic signal;
S3.3, truncating in real time the first-harmonic signal and the denoised second-harmonic signal in a same detection frequency, namely, when an amplitude of a triangular wave in the first-harmonic signal reaches the signal start threshold V₁, truncating the denoised second-harmonic signal at a same time period, and then extending backwards the denoised second-harmonic signal with a duration of T₁ to obtain a second-harmonic voltage signal containing characteristic gas signal;
S3.4, reading the second-harmonic voltage signal containing characteristic gas signal obtained in the sub-step S3.3, performing superposition mean calculation on periodic signals within 1 second extracted from the second-harmonic voltage signal containing characteristic gas signal as per the following formula (1), then subtracting a standalone second-harmonic signal detected in ambient air to obtain a characteristic second-harmonic signal, and inputting the characteristic second-harmonic signal into the concentration inversion model to obtain a real-time concentration value of the to-be-detected gas, wherein the formula (1) is expressed as follows:
$$f ( {x}_{i} ) = \frac{{\sum }_{i = 1}^{n} f ( {x}_{i , j} )}{n} \qquad ( 1 )$$
where f(xᵢ) represents an output mean value after averaging the periodic signals within 1 second, f(x_{i,j}) represents an i-th voltage amplitude of a j-th one of the periodic signals within 1 second, and n represents a total number of the periodic signals within 1 second.

8. The signal filtering and concentration inversion method for infrared laser detection as claimed in claim 7, wherein a process for obtaining the concentration inversion model in the step S3.4 comprises the following sub-steps:
S3.4.1, acquiring filtering-processed second-harmonic historical data;
S3.4.2, subtracting a standalone second-harmonic signal detected in ambient air from a second-harmonic signal containing characteristic gas signal in the filtering-processed second-harmonic historical data, to obtain a harmonic signal containing only gas characteristic;
S3.4.3, reading the harmonic signal containing only gas characteristic obtained in the sub-step S3.4.2, and calculating a maximum voltage value max f(x) of the harmonic signal containing only gas characteristic;
S3.4.4, constructing a linear function between the maximum voltage value and a gas characteristic concentration as per the following formula (2):
$$C ( x ) = a * maxf ( x ) + b \qquad ( 2 )$$
where C(x) represents a gas concentration value corresponding to the maximum voltage value max f(x), and a and b represent dimensionless coefficients for the concentration inversion model; and
S3.4.5, obtaining the concentration inversion model, and substituting a maximum voltage amplitude of the characteristic second-harmonic signal detected in real time into the formula (2) to obtain the real-time concentration value of the to-be-detected gas.
